(19) United States
(12) Patent Application Publication
(10) Pub. No.: US 2009/0182547 A1
(43) Pub. Date: Jul. 16, 2009

(54) Adaptive Web Mining of Bilingual Lexicon for Query Translation

(75) Inventors: Cheng Niu, Beijing (CN); Lei Shi, Beijing (CN); Ming Zhou, Beijing (CN)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/015,491

(22) Filed: Jan. 16, 2008

(51) Int. Cl. G06F 17/28

(52) U.S. Cl. 704/2

(57) ABSTRACT

Mining of translation pairs for cross-language translation uses a collective extraction model to exploit the similarity among the translation pairs and adaptively learn extraction patterns for each bilingual webpage. The process queries a web search engine by an initial term translation list to retrieve bilingual webpages containing translations, and crawls websites hosting the retreived bilingual webpages to retrieve additional bilingual webpages. The process then extracts additional translation pairs from the bilingual webpages retrieved by learning translation patterns of the bilingual webpages retrieved and adaptively extreacting translation pairs from the bilingual webpages using the learned translation patterns. More bilingual webpages may be acquired for additional website crawling and translation pair extracting by querying the web search engine by additional translation pairs.

### BACKGROUND

Query translation has been an essential technique for Cross-language Information Retrieval (CLIR). Bilingual web pages contain valuable term translation information which is beneficial to CLIR. But extracting term translations directly from the bilingual web page may result in poor accuracy due to the variation of the web page layout and writing styles. One of the major reasons that CLIR does not perform as well as monolingual Information Retrieval (IR) is the presence of out-of-vocabulary (OOV) terms in the queries, which cannot be translated with a regular dictionary. According to an analysis of query logs in a real world Chinese search engine, for example, 82.9% of the top 19,124 high frequency query terms were not included in the LDC English-Chinese dictionary. Because the average length of web queries are short, e.g. 2.3 words long for English queries, and 3.18 characters long for Chinese queries, even a single occurrence of an OOV term in the query may severely deteriorate relevancy of the retrieved documents by CLIR systems.

To deal with the OOV issue, a wide-coverage bilingual dictionary is needed. However, due to the diverse and dynamic nature of the bilingual lexicons, manually compiling a wide-coverage and up-to-date term translation list requires substantial human effort. For this reason, automatic acquisition of large scale bilingual lexicons has drawn intensive research attention.

One example of automatic acquisition of bilingual lexicons is web mining. With a sharp increase of multi-lingual resources available on the Web, web mining for term translations has become a promising solution to the knowledge bottleneck problem in building a wide-coverage bilingual dictionary. Several methods have been proposed for automated extraction of term translations from the Web. For example, web mining systems are known to automatically acquire parallel web pages, from which sentences of mutual translations are aligned and then bilingual terms are extracted from the parallel sentences. Building a bilingual lexicon in this way can be of high quality, but the unavailability of large quantity of parallel web pages limited its coverage.

An alternative is to use comparable texts in addition to, or in place of parallel texts. Compared with parallel texts, comparable texts have larger quantities existing on the web. Although comparable corpus is easier to acquire than the parallel data, the quality of the mined term translations is lower, because comparable texts are not strict translations and translational terms are loosely connected. For this reason, extracting translations from comparable text usually suffers from low accuracy.

Multi-lingual anchor texts are also exploited for mining term translations based on the observation that multi-lingual anchor texts pointing to the same page tend to be translations. Though some company names can be found in this way, the majority of individual names, places or other terms are unlikely to be a subject of a web page and cannot be identified by this approach. All above methods suffer from low coverage problem, since the resources these methods use are still too scarce even on the web to build a wide-coverage term translation dictionary.

In Asian languages, such as Chinese, Japanese, and Korean, however, there exist a large number of partially bilingual web pages, in which the mono-lingual text in an Asian language contains several sporadically interlaced English words. In such pages, most content is written in one baseline language, such as Chinese, and the occasional appearance of terms in the other language such as English in the page is almost inevitably accompanied with their translations. There are a large number of such bilingual web pages on the web and they provide a rich resource for mining term translations.

Previous research on mining term translations from such bilingual web pages primarily focused on analyzing bilingual search snippets. Given an input term in the source language, the search engine searches the term in documents written in the other language. The returned snippets containing the term are collected, and translations are extracted from the snippets. This mining scheme is referred to as search snippet-based scheme. This approach relies heavily on co-occurrence statistics of the terms and their translations in the search snippets. Although a quite large amount of term translations can be acquired using search snippet-based mining scheme, the scheme may fail to extract low frequency term translations due to the following two facts. First, if a term translation pair occurs only a few times on the Web, the translation of the term may not be retrieved by the search engine since the search engine ranks web pages based on the PageRank algorithm which is irrelevant to the occurrence of its translation. As a result the top-n returned snippets may not contain the translation. Second, even if the returned search snippets contain the translation, depending heavily on co-occurrence frequency by the existing translation extraction algorithm is not very reliable.

To complement search snippet-based mining, another existing method crawls the Web for bilingual web pages, and then identifies term translations directly from these web pages using some predefined patterns, e.g., a term followed by its translation surrounded by parenthesis. However, such patterns are far from being accurate and complete due to the divers writing styles and layout arrangement of web documents.

Given the importance of automatic query translation for CLIR, it is desirable to develop new techniques for mining translation pairs for cross-language translation and extracting translations from bilingual webpages.

### SUMMARY

In this disclosure, a method for mining translation pairs for cross-language translation is disclosed. The method uses a collective extraction model to exploit the similarity among the translation pairs and adaptively learn extraction patterns for each bilingual webpage. The method queries a web search engine by an initial term translation list to retrieve bilingual webpages containing translations, and crawls websites hosting the retrieved bilingual webpages to retrieve additional bilingual webpages. The method then extracts additional translation pairs from the bilingual webpages retrieved by learning translation patterns of the bilingual webpages retrieved and adaptively extracting translation pairs from the bilingual webpages using the learned translation patterns. More bilingual webpages may be acquired, and additional website crawling and translation extraction may be performed by querying the web search engine using additional translation pairs.

In some embodiments, classifiers are trained and applied to classify webpage blocks and extraction patterns, and to extract term translations based on the results of block classification and extraction pattern classification. Maximum entropy models based on multiple feature functions are used for training, refining and applying the classifiers.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE FIGURES

The detailed description is described with reference to the accompanying figures. In the figures, the left-most digit(s) of a reference number identifies the figure in which the reference number first appears. The use of the same reference numbers in different figures indicates similar or identical items.

FIG. 1 shows an exemplary bilingual webpage containing translation pairs occurring with similar pattern.

FIG. 2 is a block illustration of an exemplary process for mining translation pairs for cross-language translation.

FIG. 3 illustrates an example of the mining process of FIG. 2.

FIG. 4 is a block illustration of an exemplary process for extracting translation pairs.

FIG. 5 is a block representation of an example of document tree model (DOM tree) used in an embodiment of the techniques described herein.

FIG. 6 shows an exemplary environment for implementing the techniques of the present disclosure.

### DETAILED DESCRIPTION

The present disclosure describes techniques of mining translation pairs for cross-language translation and extracting translations from bilingual webpages. In this disclosure, a “translation pair” refers to a pair of a source language term and a target language term which is a proper translation of the former. A “language term” may have one or more words or characters of the respective language. In this disclosure, bilingual webpages containing English-Chinese translation pairs are used for illustration. The techniques for mining translation pairs for cross-language translation and extracting translation pairs, however, may be applied to any languages.

The disclosed collective extraction model is able to learn a web page's specific extraction patterns, and combine the patterns with other useful features such as co-occurrence frequency and transliteration etc. for translation extraction. Rather than focusing on snippets, the disclosed techniques crawl the bilingual web pages and extract all term translations available on the page.

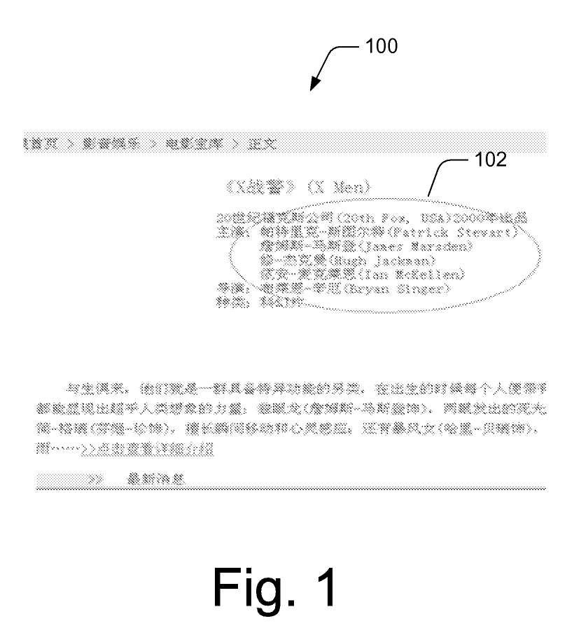

Instead of extracting each translation pair independently, the techniques exploit the fact that translation pairs may occur with similar pattern in the same block of a bilingual web page, and model the influences among individual translation extraction. FIG. 1 shows an exemplary bilingual webpage 100 containing translation pairs 102 occurring with similar pattern. The collective extraction model can potentially identify low frequency translation pairs on which the search snippet-based approach or static pre-define patterns may fail.

To compile a bilingual lexicon by mining the web, the present disclose techniques mainly focus on extracting term translations in bilingual web pages. In this disclosure, the term “bilingual web page” broadly refers to any web page that contains content written in two or more languages (e.g., a source language and a target language). A bilingual webpage is particularly relevant to the disclosed techniques if source language terms and their target language translations appear in the same page. For many language pairs, especially Asian ones such as Chinese, Japanese, Korean etc, a large volume of bilingual web pages are found on the web.

Previous methods use the web search engine to search a given term as a keyword and try to extract its translations in the top portion of the returned search snippets of bilingual web pages. Such methods have several shortcomings. First, it requires that the term to be translated be given. But in most cases for compiling a comprehensive bilingual lexicon, the terms are unknown beforehand. Second, many term translation pairs do not occur frequently on the web, therefore depending only on search engines is not reliable since the search may not return the appropriate bilingual pages for these low frequency terms. In contrast, the present disclosed method does not required source language terms to be given, but rather mines all translation pairs present in bilingual web pages. The disclosed method uses existing known term translations to find bilingual web pages based on the fact that related terms and translations tend to exist on the same page. In one embodiment, rather than mining translations in search snippets, the method downloads the whole bilingual page and extracts translations pairs on the downloaded bilingual pages. As a result, even low frequency term translations can be identified.

To extract term translation pairs on bilingual web pages, the disclosed method adaptively learns extraction patterns to facilitate term translation mining. This potentially has several advantages over previous methods. Incorporating extraction patterns can be much more effective in identifying low frequency term translations than the existing co-occurrence frequency based methods. Although a fixed number of pre-defined extraction patterns employed in some existing systems can do similar work, those existing systems suffer from limited coverage due to the diverse and dynamic nature of the web. The presently disclosed techniques, in some embodiments, enhance the pattern based extraction by adaptively learn extraction patterns on individual pages. Based on the observation that term translation pairs occur with similar patterns in the same block or the same page or even the same whole website, such patterns can be learned and used to accurately identify term translation pairs on the page. Therefore, the disclosed techniques can be also effective where pre-defined patterns do not work or when patterns vary over different bilingual web pages.

Furthermore, different from the conventional web information extraction task which is targeted on text chunks on the web page, the term translation module disclosed herein may also extract navigation blocks or even advertisement blocks as long as the term translations are present.

### Overall Term Translation Mining Scheme

The techniques are described in further detail below. Exemplary processes are described using block illustrations and flowcharts. The order in which the method is described is not intended to be construed as a limitation, and any number of the described method blocks may be combined in any order to implement the method, or an alternate method.

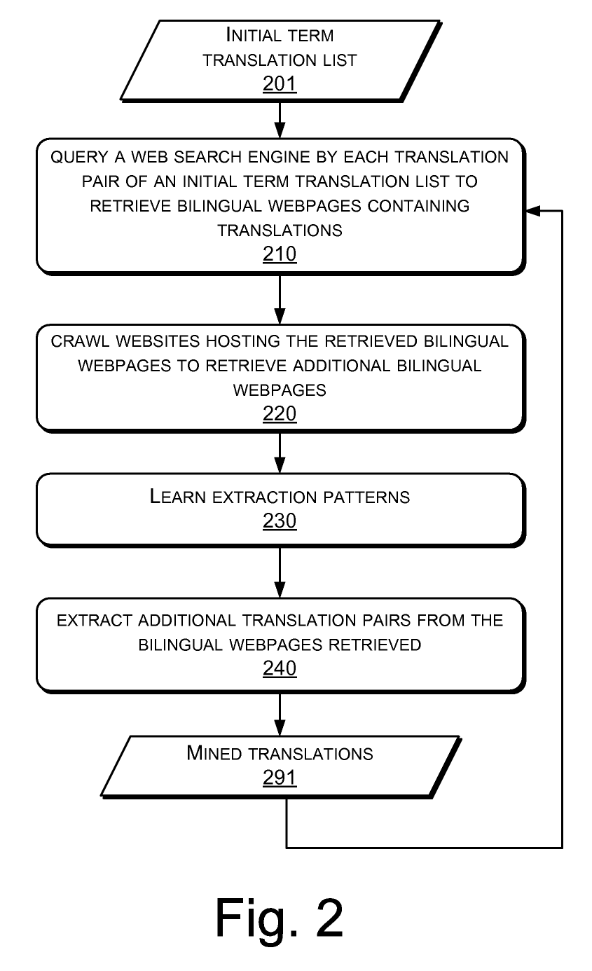

FIG. 2 is a block illustration of an exemplary process for mining translation pairs for cross-language translation. Block 201 represents an existing known term translation list used as an initial term translation list to initiate the process. The initial term translation list 201 may have a plurality of translation pairs.

At block 210, the process queries a web search engine by each translation pair in the initial term translations list 201 to retrieve bilingual web pages containing translations.

At block 220, the process crawls each web site hosting the retrieved web pages to collect more bilingual web pages.

At block 230, the process learns extraction patterns on each bilingual webpage, as will be discussed in further detail below.

At block 240, for each bilingual web page being collected, term translation extraction is performed based on a collective extraction model as described in further detail below. The term translation extraction results in mined translations 291, which may be used for collecting more bilingual webpages and extracting more translations by returning to block 210.

The key component of the mining scheme shown in FIG. 2 is blocks 230 and 240 in which the process learns extraction patterns and extracts additional translation pairs based on the learned extraction patterns. It is noted that although blocks 230 and 240 are described separately, they may be performed together as a single step. The recursive approach is based on the observation that a bilingual web page usually contains multiple term translation pairs, and a bilingual web site usually hosts multiple bilingual web pages.

The above term translation mining scheme is designed to address the two main issues for mining term translations from bilingual web pages. The first issue is how to locate the web pages that contains term translation pairs. The other is how to accurately extract the term translation pairs from the located web pages.

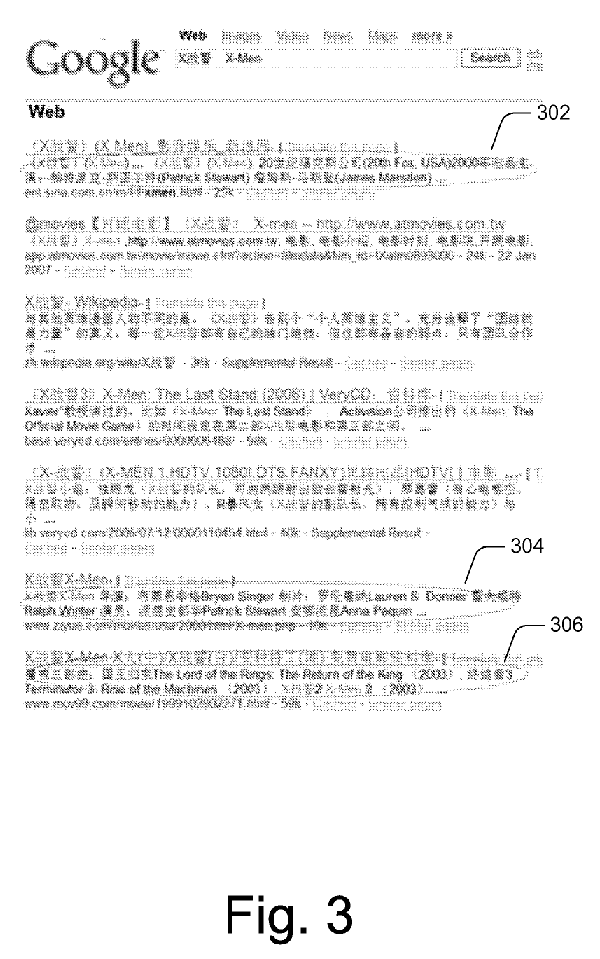

FIG. 3 illustrates an example of the mining process of FIG. 2. In this example, English term “x-men” and its Chinese translation are known, and together form a translation term pair. A web search using a search engine (e.g., Google) by entering the translation term pair as a conjunctive search phrase results in multiple webpages containing translations of many English terms other than “x-men” in these pages. These other English terms may be related to “x-men” in their context, but are additional language terms different from “x-men”. The extraction of these additional language terms and their Chinese translations can be done quite precisely since on each webpage (302, 304 or 306) they are arranged in very similar patterns, although the pattern may be different from one webpage to another (e.g., between 302 and 304). Such similarity is also demonstrated in FIG. 1.

As will be shown in further detail later in this description, in one embodiment, in order to learn translation patterns of the bilingual webpages retrieved, the process performs the following steps:

identifying webpage blocks containing translation pairs;

classifying the identified webpage blocks into at least two different classes;

identifying candidate translation patterns in each identified and classified webpage block; and

classifying identified candidate translation patterns into at least two different classes.

In one embodiment, to adaptively extract translation pairs from the bilingual webpages, the process classifies each candidate translation pair using a plurality of features, such as multiple feature functions used in a maximum entropy model.

In one embodiment, to extract additional translation pairs from each bilingual web page, the process first identifies a plurality of candidate translations in which a source language term form pairs with a set of corresponding target language terms, and then identifies a true candidate translation from the plurality of candidate translations using a translation classifier. To identify the plurality of candidate translations, a continuous source language word sequence may be set as a candidate source language term, and corresponding target language translation candidates may be then identified. For example, the process may select continuous target language word sequences which are within a context window surrounding the candidate source language term, and are started and ended with either a delimiter or a source language word, and then acquire the corresponding target language translations from the continuous target language word sequences using a search snippet-based translation mining system.

In another embodiment, in order to identify the true candidate translation from the plurality of candidate translations, the process performs the following acts: (i) classify blocks of the retrieved webpages using a block classifier into at least a first category having many translations and the second category having few translations; (ii) classify candidate translation patterns using a pattern classifier into at least a first category having a strong pattern and a second category having a weak pattern; and (iii) for each source language term, identify a corresponding target language term using a translation extraction classifier based on results of the block classifier and the pattern classifier. The identified corresponding target language term provides a true candidate translation of the source language term.

The block classifier and the pattern classifier may be trained by identifying salient webpage blocks and extraction patterns to facilitate a preliminary translation extraction, and refining the block classifier and the pattern classifier based on results of the preliminary translation extraction to facilitate an improved translation extraction.

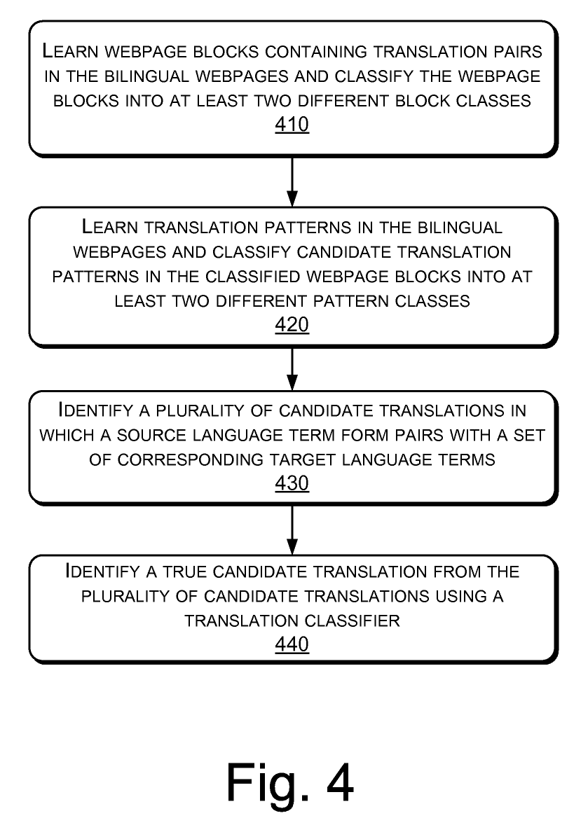

Another aspect of the present disclosure is a method for extracting translation pairs from the bilingual webpages. FIG. 4 is a block illustration of an exemplary process for extracting translation pairs.

At block 410, the process learns webpage blocks containing translation pairs in the bilingual webpages and classifies the webpage blocks into at least two different block classes.

At block 420, the process learns translation patterns in the bilingual webpages and classifies candidate translation patterns in the classified webpage blocks into at least two different pattern classes.

With the classification of webpage blocks and the classification of translation patterns, the process then adaptively extracts translation pairs from the bilingual webpages. In the example shown in FIG. 4, this is accomplished by two steps described by blocks 430 and 440.

At block 430, the process identifies a plurality of candidate translations in which a source language term form pairs with a set of corresponding target language terms.

At block 440, the process identifies a true candidate translation from the plurality of candidate translations using a translation classifier.

The detail of the classifiers used for classify webpage blocks, translation patterns and candidate translations will be further described in a later section of this disclosure.

In contrast to search snippet-based extraction where the same translation pair may occur many times across multiple snippets, the disclosed technique does not rely on co-occurrence statistics to extract term translation in a single web page, because a translation pair may occur only once in one page. Frequency related features, e.g. word frequency and word-word cohesion, which are important for snippet-based extraction, may not contribute to web page based extraction described herein. Accordingly, the present disclosure introduces new techniques for web page based extraction. The following sections show further detail these new techniques which are used to dynamically learn patterns in bilingual pages and extract translation pairs with the learned patterns.

### Collective Extraction Model Based on Classifiers

Given a Chinese web page containing English words, the candidate translations are first identified based on the following heuristics:

Set a continuous English word sequence as candidate English term T_{E}. Then for each T_{E}, its corresponding Chinese translation candidates {T_{C}} are identified using the following two heuristics: (i) all the continuous Chinese character sequences which are within a window surrounding the candidate English term T_{E}, and are started and ended with either a delimiter or a English word; (ii) use a search snippet-based translation mining system (described in further detail herein below) to acquire translations for T_{E} from the continuous Chinese character sequences satisfying the first heuristic. For example, among the returned top 100 translation candidates, a candidate occurring within the context window surrounding T_{E} may be set as a Chinese candidate.

It is noted that the search snippet-based mining scheme is leveraged here to identify translation candidates, different from the conventional methods using search snippet-based mining. As has been noted, conventional snippet-based mining cannot provide accurate extraction for low frequency translation pairs. However, with the disclosed techniques, global analysis of the web page layout may result in additional information which can be combined with the snippet-based mining results to achieve better results. For example, global analysis of the webpage layout may conclude that the Chinese translation of T_{E} is within its left or right window, i.e. a substring of context (T_{E}). Combining such additional information with snippet-based mining results can produce highly accurate extraction results even for low frequency translation pairs.

In one embodiment, given T_{E} and a set of corresponding {T_{C}}, the term translation extraction task is formulated within a binary classification framework which is described as follows:

$$Tag ( {T}_{E} , {T}_{C} ) = ( \begin{matrix}1 , & if {T}_{E} and {T}_{C} are translational \\ - 1 , & otherwise\end{matrix}$$

with the constraint that for each T_{E} there is at most one Tc that has Tag (T_{E}, T_{C})=1.

Classification of each (T_{E}, T_{C}) pair individually is a difficult task. However, it is observed that many translations may co-occur in the same block of the same page following similar patterns. Furthermore, web pages in the same web site may present similar patterns for translation extraction. Based on these two observations, it is possible to identify the web page blocks containing term translations, and learn web layout based patterns for translation extraction. Although the correlation among different translation extractions can be well studied using relational Markov model, doing so is not the most preferred. The time complexity of the inference from a relational Markov model is in general exponential in the amount of nodes. This makes the term translation mining task intractable since a web page may consist of hundreds of candidate translations.

To model the correlation among different translation extraction, and to make the computation tractable, a simplified classification scheme (labeling approach) may be used. In one embodiment, the following labeling approach is adopted:

(i) Classify web page regions into one of the two categories {Has_Many_Translations, Has_Few_Translations};

(ii) Classify each candidate extraction patterns into one of the two categories {Strong_Pattern, Weak_Pattern}; and

(iii) Based on the block and pattern classification, for each English term TE, identify its corresponding Chinese translation TF; or NULL if there is not any.

To further refine the process, one may first identify salient web page blocks and extraction patterns to facilitate the translation extraction, and then based on the extraction quality and quantity to refine the block and pattern classification which is used to further improve the extraction. The embodiment may implement training of the following three classifiers:

Classifier I—Classify web page blocks;

Classifier II—Classify extraction patterns;

Classifier III—Extract term translations based on the classification results from Classifier I and II.

The training of these three classifiers is further described below.

### Identifying Web Page Blocks Containing Term Translations

According to one embodiment of the described techniques, relevant blocks are first identified from the web page in order to precisely extract target information from the web page. Block identification is important because target objects tend to have similar patterns in the same block. Different from the conventional web information extraction task which is targeted on text chunks on the web page, term translation module of the techniques disclosed herein may also extract navigation blocks or even advertisement blocks as long as the term translations are present.

A salient block identification algorithm may be performed on the Document Object Model (DOM) of the bilingual web page. DOM is an application programming interface for valid HTML documents. In DOM, the logical structure of a HTML document is represented as a tree where each node belongs to some pre-defined node types (e.g. Document, DocumentType, Element, Text, Comment, ProcessingInstruction etc.). Among all these types of DOM nodes, the most relevant to the purpose here are Element nodes (corresponding to each HTML tag) and Text nodes (corresponding to continuous text chunks). Furthermore, xpath of a DOM tree node is defined as the string concatenating the tag's HTML tag and the tags of all its parents.

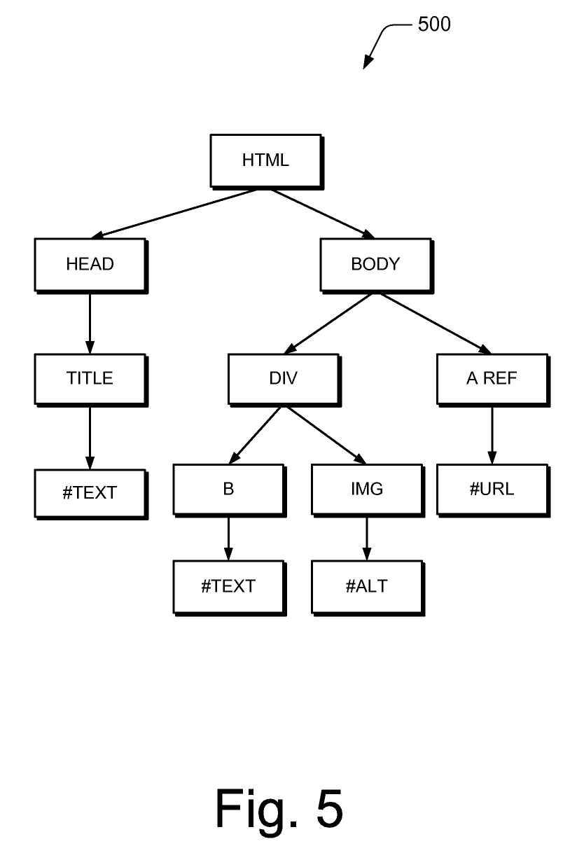

FIG. 5 is an illustration of an example of document tree model (DOM tree) used in an embodiment of the techniques described herein. The DOM tree 500 has multiple nodes such as HTML tags (HEAD, BODY, TITLE, DIV, etc.). The xpath of a DOM tree node is defined as the string concatenating the tag's HTML tag (e.g., TITLE) and the tags of all its parents (e.g., HEAD and HTML).

It is not a trivial task to develop a general block identification algorithm, and the existing algorithm, which focuses on text body extraction, or advertisement filtering, may not serve this purpose. It has been observed that blocks associated with the same xpath usually contain similar content. Based on this observation, one embodiment of the present techniques regards any two DOM nodes associated with the same xpath to be in the same block. Each block containing sufficiently many (e.g., more than ten) English terms are classified into the following two categories:

ContainManyTranslation: if more than 50% of the English terms have Chinese translations existing in the context window;

ContainFewTranslation: if less than 50% of the English terms have Chinese translations existing in the context window.

In the above embodiment, it is preferred not to introduce more fine-grained categories due to the concern of the classification performance degradation when dealing with multiple classes. To perform the block classification, the following features are designed:

(i) the ratio of the English (source language) words whose dictionary-based translation or their transliteration can be found in a context window;

(ii) the ratio of the English words whose dictionary-based translation or their transliteration cannot be found in the context window;

(iii) the total number of English words in the block;

(iv) the ratio of English terms whose snippet-based translation results can be found in the context window (a snippet-based translation model is described later in this description); and

(v) a translation direction tendency based on the number of English words in the block which find their dictionary-based translation in their left context window, and the number of English words in the block which find their dictionary-based translation in their left context window. In one embodiment, the translation direction tendency is defined as follows: suppose N_{left} English words find their dictionary-based translation in their left context window, while N_{right} English words find their dictionary-based translation in their left context window, the feature value is then set as:

$$\frac{max ( {n}_{left} , {n}_{right} )}{min ( {n}_{left} , {n}_{right} )} .$$

The above feature value is based on an intuition that English terms and their Chinese translations should follow the same order in the same block.

Based on the above features, a maximum entropy model is applied as follows:

$$p ( tag \vert block ) = \frac{1}{Z} {\prod }_{i} exp [ {λ}_{i} {f}_{i} ( tag , block ) ]$$

Where Z is the normalization factor, fᵢ(tag, block) represents the feature functions defined above, and λᵢ is the corresponding weights trained with iterative scaling.

### Learn Patterns for Term Translation Extraction

Local context patterns are useful for extracting term translations. A typical example is the Chinese characters followed by its English translations surrounded by “(” and “)”. A scheme of learning surface patterns for extracting term translations from search snippets may learn a set of general extraction patterns. Such a scheme works well for extraction from search snippets, but may not be adequate for the present purpose, because it has been observed that each web page has its special layout patterns for translation extraction. For this reason, the present disclosure proposes an adaptive pattern learning scheme to learn web page/site specific patterns.

In addition to surface text based patterns, the proposed pattern learning scheme may learn both surface text patterns and patterns that include HTML tags.

An exemplary pattern learning procedure is described as follows: given a candidate translation pair, <Chinese Term, English Term>, the Chinese character or English Word prior to the pair is denoted as Wₚ. If the translation pair is at the beginning of a text node, then Wₚ is set as < >. The Chinese character sequence or the English word sequence following the translation pair is denoted as W_{f}. If the end of the translation pair is also at the end of a text node, W_{f} is set as </>. Then the character sequence from Wₚ to W_{f} after replacing the Chinese term with string “T_{C}” and replacing the English with string “T_{E}” is regarded as an extraction pattern.

In one embodiment, similar to a block, each pattern is categorized into two classes:

StrongPattern: more than 80% of the candidate pairs following this pattern are really translations; and

WeakPattern: otherwise.

To perform the pattern classification, the following features are designed:

(i) among all candidate pairs following the pattern, the ratio of the English words whose dictionary-based translation or their transliteration can be found in the context window;

(ii) among all candidate pairs following the pattern, the ratio of the English words whose dictionary-based translation or their transliteration cannot be found in the context window;

(iii) the average length ratio of Chinese term to the English term; and

(iv) the ratio of English terms whose snippet-based translation results can be found in the context window.

Similar to block classification, in one embodiment maximum entropy modeling is used for a binary pattern classification.

### Term Translation Extraction

Once the blocks and extraction patterns are labeled, each translation candidate pair can be classified using the following features:

(i) the classification label of the block containing the candidate pair;

(ii) the classification label of the extraction pattern for the candidate pair;

(iii) whether the candidate pair can be confirmed by snippet-based mining scheme;

(iv) the ratio of the English words whose dictionary-based translation or their transliteration can be found in the Chinese term;

(v) the ratio of the English words whose dictionary-based translation or their transliteration cannot be found in the Chinese term;

(vi) the ratio of the Chinese characters whose dictionary-based translation or their transliteration cannot be found in the English term; and

(vii) the ratio of the Chinese characters whose dictionary-based translation or their transliteration can be found in the English term.

Using the features defined above, in one embodiment maximum entropy model is called to classify the translation candidates.

### Transliteration and Search Snippet-Based Translation Mining

The following describes two related modules transliteration and search snippet-based translation mining, which are used as features to facilitate the term translation extraction from the bilingual web pages as described above.

Transliteration: To facilitate proper name translation identification, a transliteration module is developed so that terms with higher transliteration score are treated more likely to be translations. To measure transliteration score, the pair of terms is first converted into a common form according to their pronunciations using the International Phonetic Alphabet and then a similarity function is applied on their sound representation to measure distance. Due to the variation of pronunciations in disparate languages such as Chinese and English, a statistical method may be used to model the likelihood for a sound representation in one language to be transformed to that of the other language. If S^{f} and S^{e} denote sound representation in language f and e, and c^{f} and c^{e} denote individual sound characters, then S={c₁, c₂, . . . , cₙ}, which is a sequence of sound letters representing its pronunciation. The probability of transforming S^{f} to S^{e} can be modeled as:

$$Pr ( {S}^{e} \vert {S}^{f} ) = {\sum }_{A} Pr ( {S}^{e} , A \vert {S}^{f} ) = {\sum }_{A} Pr ( A \vert {S}^{f} ) \times Pr ( {S}^{e} \vert A , {S}^{f} )$$

where A is the alignment of sound letters c that compose S. It may be assumed that there is only one-to-one alignment between sound letters and no cross-alignment is allowed. It may be further assumed that the prior probability Pr(A|S^{f}) has a uniform distribution P^{u}. Then the probability is calculated as

$$Pr ( {S}^{e} \vert {S}^{f} ) = {P}_{u} {\sum }_{A} Pr ( {S}^{e} \vert A , {S}^{f} ) = {P}_{u} {\sum }_{A} {\prod }_{{c}^{e} ∈ {S}^{e}}^{{c}^{f} ∈ {S}^{f}} P ( {c}^{e} \vert {c}^{f} )$$

where p(c^{e}″c^{f})) is the transformation probability of the aligned sound letters c^{f} and c^{e}. A “null” letter is introduced so that deleting a sound letter can be modeled as equivalent to aligning to “null”, while an insertion can be regarded as a deletion on the other side. All these transformation probability parameters may be estimated using the Expectation-Maximization algorithm which has been trained on a large number of sample proper name transliteration pairs. To calculate the transliteration score, the Viterbi Approximation of the above formula may be taken and a Viterbi decoder may be used to find the best alignment. The final transliteration score is the Viterbi alignment probability normalized by the number of sound characters in the terms' sound representations.

$$Score ( {S}^{e} , {S}^{f} ) \approx \frac{{max}_{A} Pr ( {S}^{e} , A \vert {S}^{f} )}{\vert {S}^{f} \vert + \vert {S}^{e} \vert} = \frac{{max}_{A} {\prod }_{{c}^{e} ∈ {S}^{e}}^{{c}^{f} ∈ {S}^{f}} P ( {c}^{e} \vert {c}^{f} )}{\vert {S}^{f} \vert + \vert {S}^{e} \vert}$$

Search Snippet-based Term Translation Mining: A search snippet-based term translation mining system may be used to identify salient translation pair in a given bilingual web page, hence facilitate the adaptive pattern learning.

In the search snippet-based method, the term in the source language is submitted to the search engine to retrieve snippets written in the target language. Within the collected snippets, it extracts translation candidates and chooses the most semantically-close translations for each unknown query term from the candidates. In order to extract candidates in the snippets written in the target language, correct lexical boundary needs to be identified. The concept of SCPCD may be used for this purpose. SCPCD combines symmetric conditional probability (SCP) and context dependency (CD) as their product. SCP is defined as:

$$SCP ( {w}_{1} … {w}_{n} ) = \frac{{freq ( {w}_{1} … {w}_{n} )}^{2}}{\frac{1}{n - 1} {\sum }_{i = 1}^{n - 1} freq ( {w}_{1} … {w}_{i} ) freq ( {w}_{i + 1} … {w}_{n} )}$$

where w₁ . . . wₙ is the word n-gram and freq(w₁ . . . wₙ) is the frequency of the n-gram. SCP measures whether the n-gram should be regarded as a term.

Context dependency (CD) measures whether the n-gram could be merged with its context to form an independent term. CD is defined as

$$CD ( {w}_{1} … {w}_{n} ) = \frac{LC ( {w}_{1} … {w}_{n} ) RC ( {w}_{1} … {w}_{n} )}{{freq ( {w}_{1} … {w}_{n} )}^{2}}$$

where LC(w₁ . . . wₙ) is the number of unique left adjacent words, and RC(w₁ . . . wₙ) is the number of unique right adjacent words.

After translation candidates are extracted, the similarity between the query term and each candidate are measured to choose the most semantically close translation among them. One exemplary method for such measurement uses Chi-square test (χ²) that depends on the co-occurrences of the query term and its translation candidates on the web. Given a query term s and a translation candidate t, the chi-square test can be computed as

$${S}_{{χ}^{2}} ( s , t ) = \frac{N \times {( a \times d - b \times c )}^{2}}{( a + b ) \times ( a + c ) \times ( b + d ) \times ( c + d )}$$

where N is the total number of web pages; a is the number of pages containing both s and t; b is the number of pages containing s but not t; c is the number of pages containing t but not s; d is the number of pages containing neither s nor t.

Another way to identify translation is the context vector method. It is based on the idea that the term and its translation should have similar context in the search result snippets. The context vector is constructed by collecting the context words weighted by their tf-idf scores. Finally the similarity between a query term s and the translation candidate t is estimated with the cosine measure of their context vectors:

S_{cv}(s, t)=cosine(cvₛ, cvₜ)

where cvₛ and cvₜ are the context vectors of s and t.

### Implementation Environment

The above-described techniques may be implemented with the help of a computing device, such as a server, a personal computer (PC) or a portable device having a computing unit.

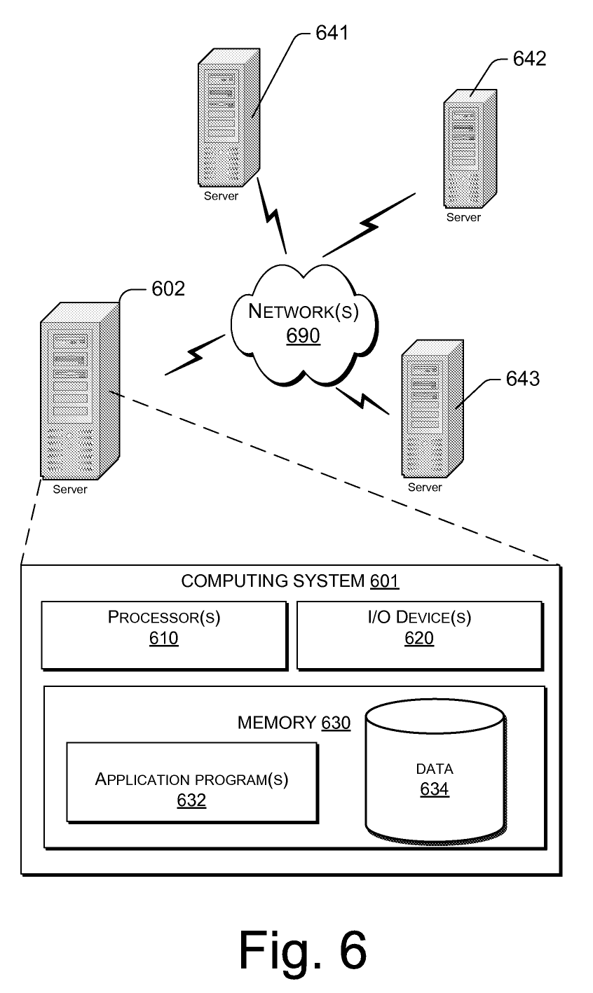

FIG. 6 shows an exemplary environment for implementing the method of the present disclosure. Computing system 601 is implemented with computing device 602 which includes processor(s) 610, I/O devices 620, computer readable media (e.g., memory) 630, and network interface (not shown). The computer device 602 is connected to servers 641, 642 and 643 through networks 690.

The computer readable media 630 stores application program modules 632 and data 634 (such as translation data). Application program modules 632 contain instructions which, when executed by processor(s) 610, cause the processor(s) 610 to perform actions of a process described herein (e.g., the processes of FIGS. 2-4).

For example, in one embodiment, computer readable medium 630 has stored thereupon a plurality of instructions that, when executed by one or more processors 610, causes the processor(s) 610 to:

(i) query a web search engine by each translation pair of an initial term translation list to retrieve bilingual webpages containing translations;

(ii) crawl websites hosting the retrieved bilingual webpages to retrieve additional bilingual webpages;

(iii) extract additional translation pairs from the bilingual webpages retrieved; and

(iv) query the web search engine by each additional translation pairs to retrieve more bilingual webpages for additional website crawling and translation pair extracting.

In one embodiment, in order to extract additional translation pairs from each bilingual web page, the plurality of instructions, when executed by a processor, causes the processor to learn translation patterns of the bilingual webpages retrieved and adaptively extract translation pairs from the bilingual webpages using the learned translation patterns.

It is appreciated that the computer readable media may be any of the suitable memory devices for storing computer data. Such memory devices include, but not limited to, hard disks, flash memory devices, optical data storages, and floppy disks. Furthermore, the computer readable media containing the computer-executable instructions may consist of component(s) in a local system or components distributed over a network of multiple remote systems. The data of the computer-executable instructions may either be delivered in a tangible physical memory device or transmitted electronically.

It is also appreciated that a computing device may be any device that has a processor, an I/O device and a memory (either an internal memory or an external memory), and is not limited to a personal computer. For example, a computer device may be, without limitation, a server, a PC, a game console, a set top box, and a computing unit built in another electronic device such as a television, a display, a printer or a digital camera.

### Conclusion

The present disclosed techniques of translation mining relates to an observation that related terms and their translations appear with similar patterns in the same page, but such patterns may differ across pages. To mine term translations from web pages, a collective extraction model is proposed to adaptively learn translation pair patterns in each page, and use the discovered translation pairs to find new pages. Experiments show that the bilingual term translations mined from the web using the disclosed techniques has high accuracy and coverage and the mind translations are very effective in improving quality of query translation and Cross Language Information Retrieval.

It is appreciated that the potential benefits and advantages discussed herein are not to be construed as a limitation or restriction to the scope of the appended claims.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method for mining translation pairs for cross-language translation, the method comprising:
querying a web search engine by each translation pair of an initial term translation list to retrieve bilingual webpages containing translations;
crawling websites hosting the retrieved bilingual webpages to retrieve additional bilingual webpages;
extracting additional translation pairs from the bilingual webpages retrieved; and
querying the web search engine by each additional translation pairs to retrieve more bilingual webpages for additional website crawling and translation pair extracting.

2. The method as recited in claim 1, wherein extracting additional translation pairs from each bilingual web page comprises:
learning translation patterns of the bilingual webpages retrieved; and
adaptively extracting translation pairs from the bilingual webpages using the learned translation patterns.

3. The method as recited in claim 2, wherein learning translation patterns of the bilingual webpages retrieved comprises:
identifying webpage blocks containing translation pairs;
classifying the identified webpage blocks into at least two different classes;
identifying candidate translation patterns in each identified and classified webpage block; and
classifying identified candidate translation patterns into at least two different classes.

4. The method as recited in claim 2, wherein adaptively extracting translation pairs from the bilingual webpages comprises:
classifying each candidate translation pair using a plurality of feature functions.

5. The method as recited in claim 1, wherein extracting additional translation pairs from each bilingual web page comprises:
identifying a plurality of candidate translations in which a source language term form pairs with a set of corresponding target language terms; and
identifying a true candidate translation from the plurality of candidate translations using a translation classifier.

6. The method as recited in claim 5, wherein identifying the plurality of candidate translations comprises:
setting a continuous source language word sequence as a candidate source language term; and
identifying corresponding target language translation candidates.

7. The method as recited in claim 6, wherein identifying the corresponding target language translation candidates comprises:
selecting continuous target language word sequences which are within a context window surrounding the candidate source language term, and are started and ended with either a delimiter or a source language word; and
acquiring the corresponding target language translations from the continuous target language word sequences using a search snippet-based translation mining system.

8. The method as recited in claim 5, wherein identifying the true candidate translation from the plurality of candidate translations comprises:
classifying blocks of the retrieved webpages using a block classifier into at least a first category having many translations and the second category having few translations;
classifying candidate translation patterns using a pattern classifier into at least a first category having a strong pattern and a second category having a weak pattern; and
for each source language term, identifying a corresponding target language term using a translation extraction classifier based on results of the block classifier and the pattern classifier.

9. The method as recited in claim 8, wherein the block classifier and the pattern classifier are trained by performing acts comprising:
identifying salient webpage blocks and salient extraction patterns to facilitate a preliminary translation extraction; and
refining the block classifier and the pattern classifier based on results of the preliminary translation extraction to facilitate an improved translation extraction.

10. The method as recited in claim 8, wherein classifying blocks of the retrieved webpages using a block classifier comprises:
applying to each block a maximum entropy model based on feature functions including at least one of the following feature functions:
(i) a ratio of source language words in the block whose transliteration or dictionary-based translation is found in a context window;
(ii) a ratio of source language words in the block whose transliteration and dictionary-based translation cannot be found in the context window;
(iii) total number of source language words in the block;
(iv) a ratio of source language terms in the block whose snippet-based translation results can be found in the context window; and
(v) a translation direction tendency based on the number of source language words in the block which find their dictionary-based translation in their left context window, and the number of source language words in the block which find their dictionary-based translation in their left context window.

11. The method as recited in claim 8, wherein classifying candidate translation patterns using a pattern classifier comprises:
applying to each pattern a maximum entropy model based on feature functions including at least one of the following feature functions:
(i) among candidate translation pairs following the pattern, ratio of source language words whose transliteration or dictionary-based translation can be found in a context window;
(ii) among the candidate translation pairs following the pattern, ratio of source language words whose transliteration or dictionary-based translation cannot be found in the context window;
(iii) average length ratio of target language term to source language term; and
(iv) ratio of target language terms whose snippet-based translation results can be found in the context window.

12. The method as recited in claim 8, wherein identifying for each source language term a corresponding target language term comprises:
applying to each target language term a maximum entropy model based on feature functions including at least one of the following feature functions:
(i) classification label of the block containing the source language term and the target language term;
(ii) classification label of the extraction pattern for the source language term and the target language term;
(iii) whether the candidate pair can be confirmed by a snippet-based mining scheme;
(iv) ratio of source language words whose transliteration or dictionary-based translation can be found in the target language term;
(v) ratio of the source language words whose transliteration or dictionary-based translation cannot be found in the target language term;
(vi) ratio of the target language words whose transliteration or dictionary-based translation cannot be found in the source language term; and
(vii) ratio of the target language words whose transliteration or dictionary-based translation can be found in the source language term.

13. A method for extracting translation pairs from bilingual webpages, the method comprising:
learning webpage blocks containing translation pairs in the bilingual webpages and classifying the webpage blocks into at least two different block classes;
learning translation patterns in the bilingual webpages and classifying candidate translation patterns in the classified webpage blocks into at least two different pattern classes; and
adaptively extracting translation pairs from the bilingual webpages using the learned translation patterns.

14. The method as recited in claim 13, wherein adaptively extracting translation pairs from each bilingual web page comprises:
identifying a plurality of candidate translations in which a source language term form pairs with a set of corresponding target language terms; and
identifying a true candidate translation from the plurality of candidate translations using a translation classifier.

15. The method as recited in claim 13, wherein adaptively extracting translation pairs from each bilingual web page comprises:
setting a continuous source language word sequence as a candidate source language term;
selecting continuous target language word sequences which are within a context window surrounding the candidate source language term, and are started and ended with either a delimiter or a source language word; and
acquiring the corresponding target language translations from the continuous target language word sequences using a search snippet-based translation mining system.

16. The method as recited in claim 13, wherein adaptively extracting translation pairs from each bilingual web page comprises:
classifying blocks of the retrieved webpages using a block classifier into at least a first category having many translations and the second category having few translations;
classifying candidate translation patterns using a pattern classifier into at least a first category having a strong pattern and a second category having a weak pattern; and
for each source language term, identifying a corresponding target language term using a translation extraction classifier based on results of the block classifier and the pattern classifier.

17. The method as recited in claim 16, wherein the block classifier and the pattern classifier are trained by performing acts comprising:
identifying salient webpage blocks and extraction patterns to facilitate a preliminary translation extraction; and
refining the block classifier and the pattern classifier based on results of the preliminary translation extraction to facilitate an improved translation extraction.

18. The method as recited in claim 16, wherein identifying for each source language term a corresponding target language term comprises:
applying to each target language term a maximum entropy model based on feature functions including at least one of the following feature functions:
(i) a classification label of a webpage block containing the source language term and the target language term;
(ii) a classification label of an extraction pattern for the source language term and the target language term;
(iii) whether the candidate pair can be confirmed by a snippet-based mining scheme;
(iv) ratio of source language words whose transliteration or dictionary-based translation can be found in the target language term;
(v) ratio of the source language words whose transliteration or dictionary-based translation cannot be found in the target language term;
(vi) ratio of the target language words whose transliteration or dictionary-based translation cannot be found in the source language term; and
(vii) ratio of the target language words whose transliteration or dictionary-based translation can be found in the source language term.

19. One or more computer readable media having stored thereupon a plurality of instructions that, when executed by a processor, causes the processor to:
query a web search engine by each translation pair of an initial term translation list to retrieve bilingual webpages containing translations;
crawl websites hosting the retrieved bilingual webpages to retrieve additional bilingual webpages;
extract additional translation pairs from the bilingual webpages retrieved; and
query the web search engine by each additional translation pairs to retrieve more bilingual webpages for additional website crawling and translation pair extracting.

20. The computer readable media as recited in claim 19, wherein in order to extract additional translation pairs from each bilingual web page, the plurality of instructions, when executed by a processor, causes the processor to:
learn translation patterns of the bilingual webpages retrieved; and
adaptively extract translation pairs from the bilingual webpages using the learned translation patterns.
